(19) United States
(12) Patent Application Publication
(10) Pub. No.: US 2025/0309486 A1
(43) Pub. Date: Oct. 2, 2025

(54) MULTI-LAYER STACK CURRENT COLLECTOR ASSEMBLY FOR BATTERY APPLICATIONS

(71) Applicant: Rivian IP Holdings, LLC, Irvine, CA (US)

(72) Inventor: Kyle BUTTERFIELD, Ladera Ranch, CA (US)

(21) Appl. No.: 19/072,819

(22) Filed: Mar. 6, 2025

Related U.S. Application Data
(60) Provisional application No. 63/570,695, filed on Mar. 27, 2024.
(60) Provisional application No. 63/728,602, filed on Dec. 5, 2024.

(51) Int. Cl. H01M 50/503; H01M 50/505; H01M 50/509; H01M 50/526; H01M 50/588; H01M 50/59

(52) U.S. Cl. CPC H01M 50/503; H01M 50/505; H01M 50/509; H01M 50/526; H01M 50/588; H01M 50/59; H01M 2220/20

(57) ABSTRACT

A current collector assembly for battery systems may include a first conductive layer with a first plurality of tabs and a second conductive layer with a second plurality of tabs, both configured to connect to battery cells in a row. An insulating layer may separate the conductive layers, which may be vertically stacked with staggered tabs. The assembly may include elongated bars or repeating conductive islands to enhance scalability and efficiency. Integrated into a battery subassembly, it supports series and parallel connections to optimize voltage and energy capacity. The design may affect electrical performance, thermal management, or high-density battery pack configurations.

### CROSS REFERENCE TO RELATED APPLICATION(S)

The present application claims the benefit of U.S. Provisional Application No. 63/570,695, entitled “MULTI-LAYER STACK CURRENT COLLECTOR ASSEMBLY”, filed Mar. 27, 2024, and U.S. Provisional Application No. 63/728,602, entitled “MULTI-LAYER STACK CURRENT COLLECTOR ASSEMBLY FOR BATTERY APPLICATIONS”, filed Dec. 5, 2024, the entirety of both are incorporated herein for reference.

### INTRODUCTION

Batteries are often used as a source of power, including as a source of power for electric vehicles that include wheels that are driven by an electric motor that receives power from the battery.

### SUMMARY

The present disclosure generally relates to a multi-layer current collector assembly. The multi-layer current collector assembly may include a first conductive layer having a first set of tabs, a second conductive layer having a second set of tabs and vertically stacked with the first conductive layer, and an insulating layer between the first conductive layer and the second conductive layer.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a perspective view of a battery module in accordance with one or more implementations.

FIG. 4 illustrates an exploded perspective view of the battery module of FIG. 3 in accordance with one or more implementations.

FIG. 5 illustrates a top view of a battery module having a current collector assembly (CCA) in accordance with one or more implementations.

FIG. 6 illustrates a top view of a current collector assembly in accordance with one or more implementations.

FIG. 7 illustrates a cross-sectional side view of a current collector assembly in accordance with one or more implementations.

FIG. 8 illustrates an example current collector assembly side view.

FIG. 9 illustrates an example current collector assembly side view.

FIG. 10A illustrates an example current collector assembly top-down view, single layer.

FIG. 10B illustrates an example current collector assembly top-down view, multiple layers.

FIG. 10C illustrates an example current collector assembly conductive island top-down view.

FIG. 11A illustrates example electrically connected conductive layers laminated between insulating layers.

FIG. 11B illustrates example electrically separate conductive layers laminated between insulating layers.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to a multi-layer current collector assembly (CCA). The multi-layer CCA may include two or more conductive layers stacked vertically with an insulating layer therebetween. Each of the two or more conductive layers may include multiple tabs extending therefrom, for coupling (e.g., welding) to one or more battery cells in an assembly or subassembly of battery cells. The battery cells and/or the assembly or subassembly of battery cells may be implemented in a battery pack, such as a battery pack for an electric vehicle.

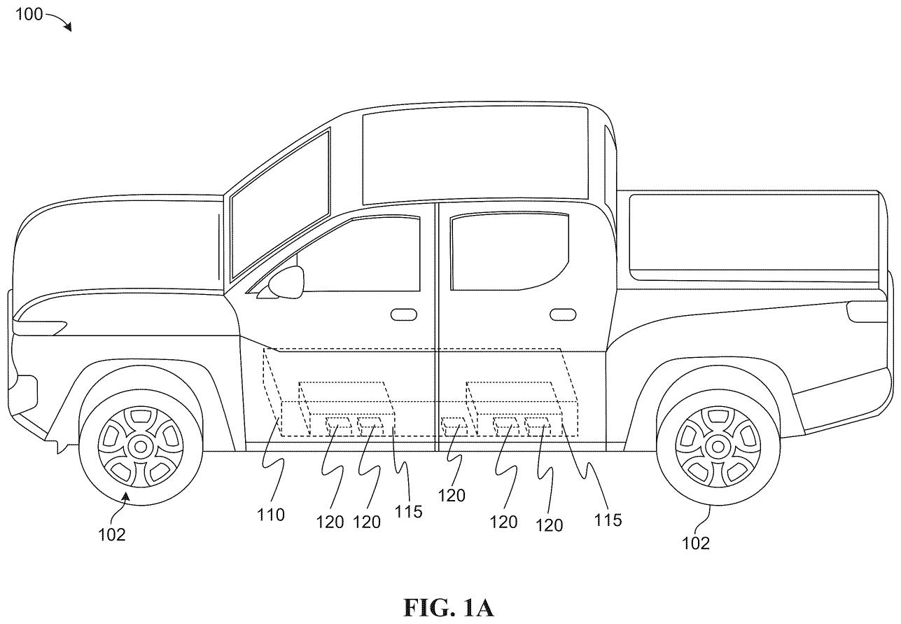

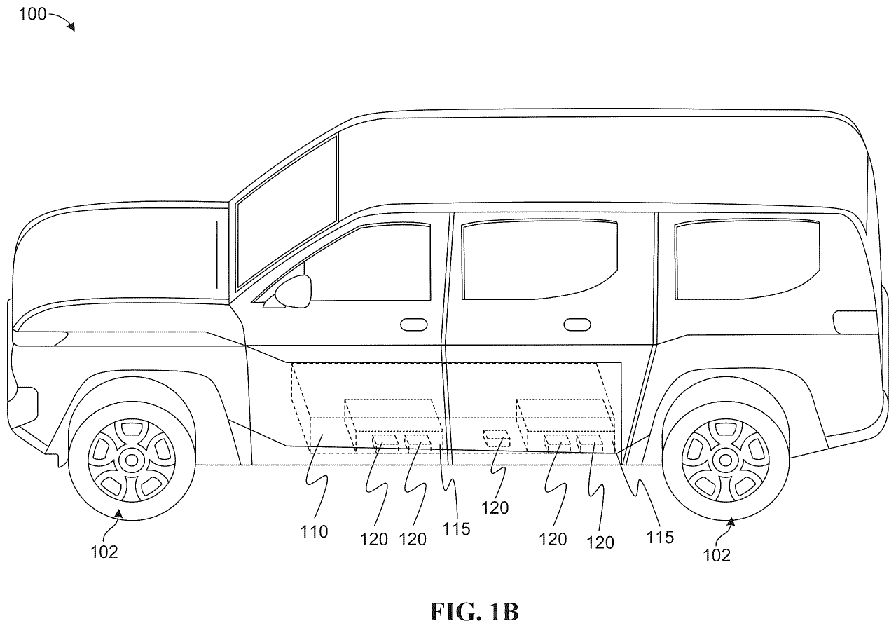

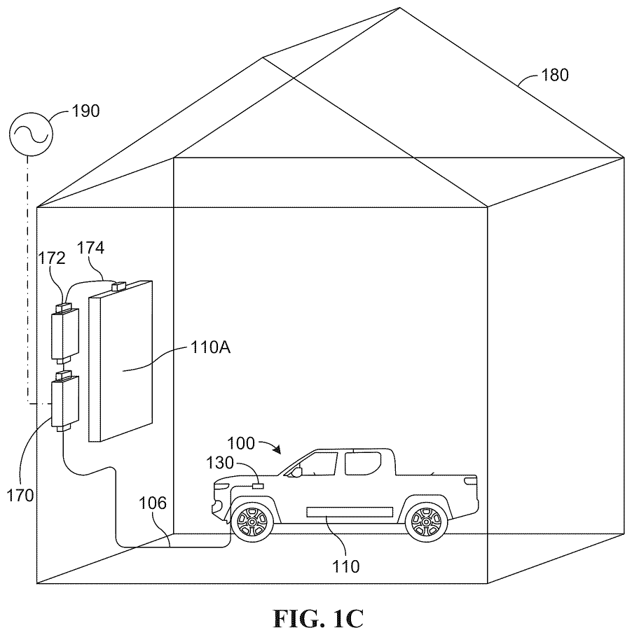

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid).

In the example of FIG. 1A, the vehicle 100 is implemented as a truck (e.g., a pickup truck) having a battery pack 110. As shown, the battery pack 110 may include one or more battery subassemblies, for example battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery subassembly, unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected with the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

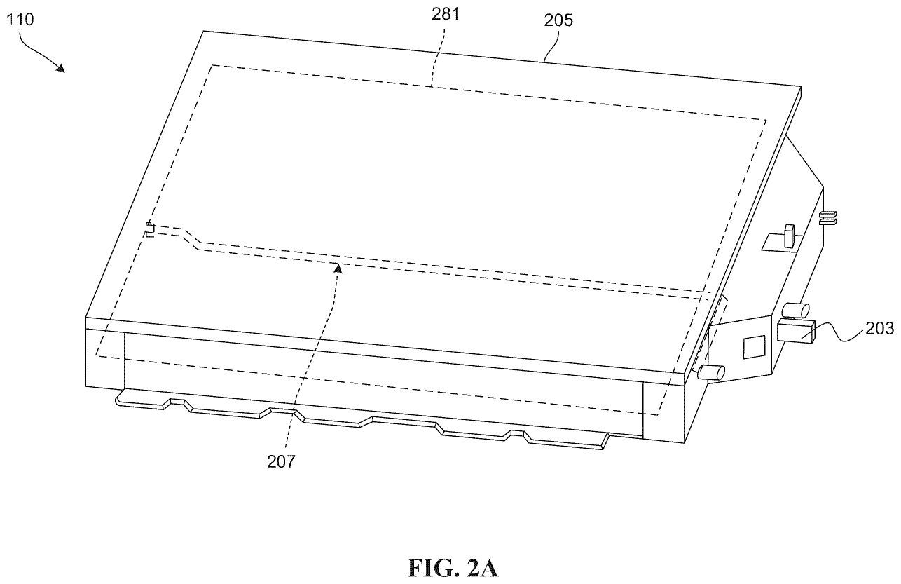

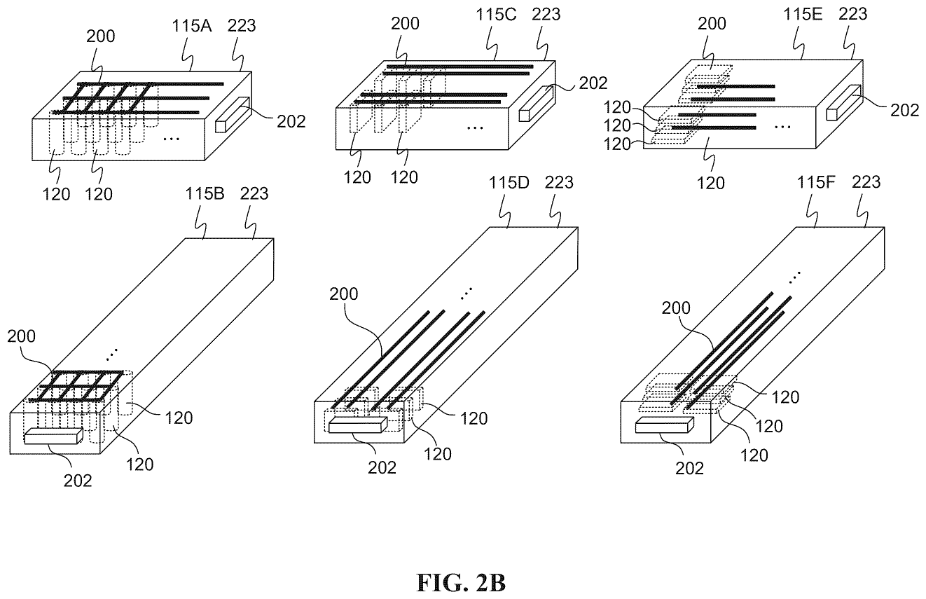

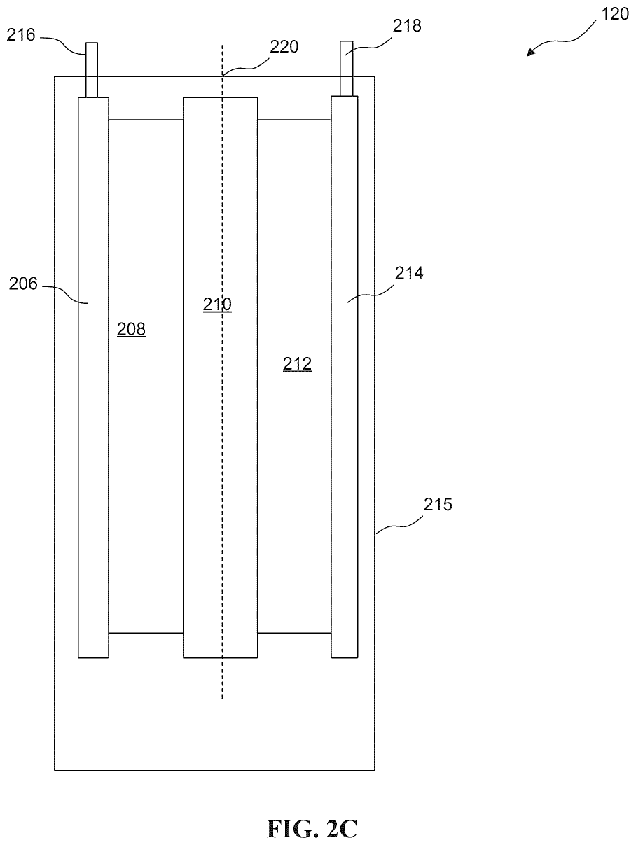

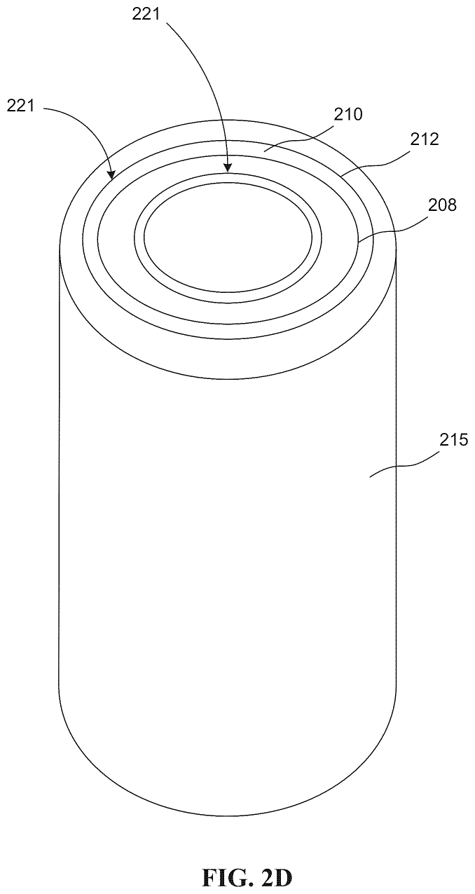

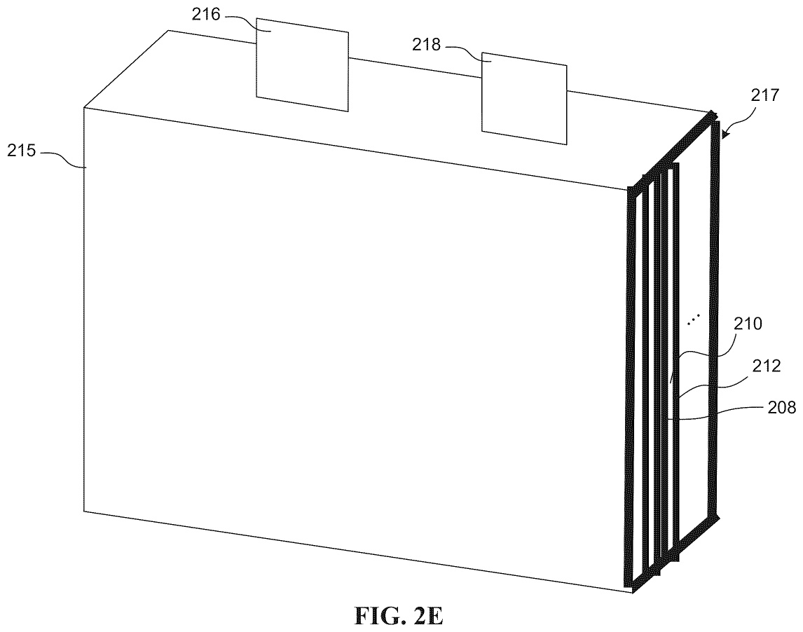

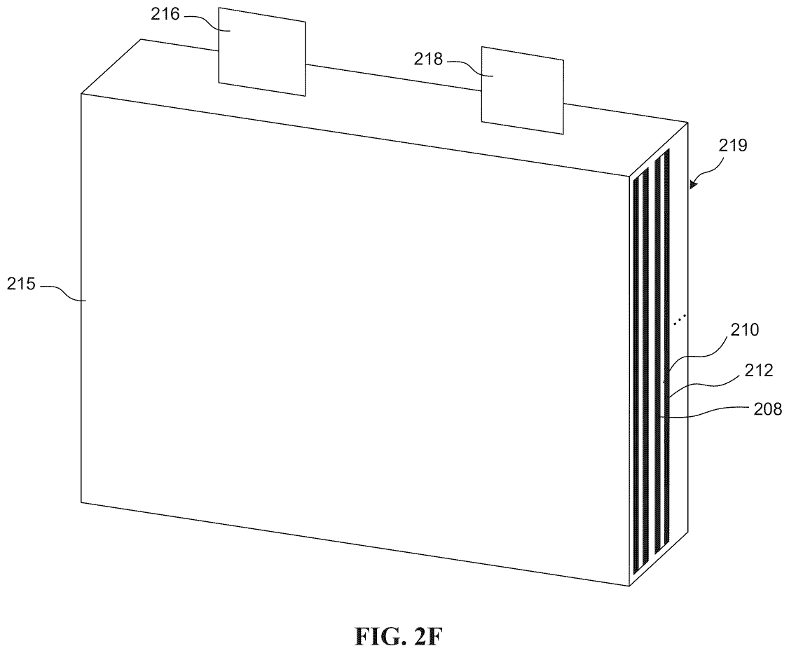

FIG. 2A depicts an example battery pack 110. Battery pack 110 may include multiple battery cells 120 (e.g., directly installed within the battery pack 110, or within batteries, battery units, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, and/or multiple battery modules 115 within the battery pack frame 205 to generate a desired (e.g., threshold) output voltage for the battery pack 110. The battery pack 110 may also include one or more external connection ports, such as an electrical contact 203 (e.g., a high voltage terminal). For example, an electrical cable (e.g., cable/connector 106) may be connected between the electrical contact 203 and an electrical system of the vehicle 100 or the building 180, to provide electrical power to the vehicle 100 or the building 180.

As shown, the battery pack 110 may include a battery pack frame 205 (e.g., a battery pack housing or pack frame). For example, the battery pack frame 205 may house or enclose one or more battery modules 115 and/or one or more battery cells 120, and/or other battery pack components. In one or more implementations, the battery pack frame 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

In one or more implementations, the battery pack 110 may include one or more thermal control structures 207 (e.g., cooling lines and/or plates and/or heating lines and/or plates). For example, thermal control structures 207 may couple thermal control structures and/or fluids to the battery modules 115, battery units, batteries, and/or battery cells 120 within the battery pack frame 205, such as by distributing fluid through the battery pack 110.

For example, the thermal control structures 207 may form a part of a thermal/temperature control or heat exchange system that includes one or more thermal components 281 such as plates or bladders that are disposed in thermal contact with one or more battery modules 115 and/or battery cells 120 disposed within the battery pack frame 205. For example, a thermal component 281 may be positioned in contact with one or more battery modules 115, battery units, batteries, and/or battery cells 120 within the battery pack frame 205. In one or more implementations, the battery pack 110 may include one or multiple thermal control structures 207 and/or other thermal components for each of several top and bottom battery module pairs. As shown, the battery pack 110 may include an electrical contact 203 (e.g., a high voltage connector) by which an external load (e.g., the vehicle 100 or an electrical system of the building 180) may be electrically coupled to the battery modules and/or battery cells in the battery pack 110.

FIG. 2B depicts various examples of battery modules 115 that may be disposed in the battery pack 110 (e.g., within the battery pack frame 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the battery pack frame 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the battery pack frame 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the battery pack frame 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the battery pack frame 205) may include or define a plurality of structures for positioning of the battery cells 120 directly within the battery pack frame 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, sodium ion battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

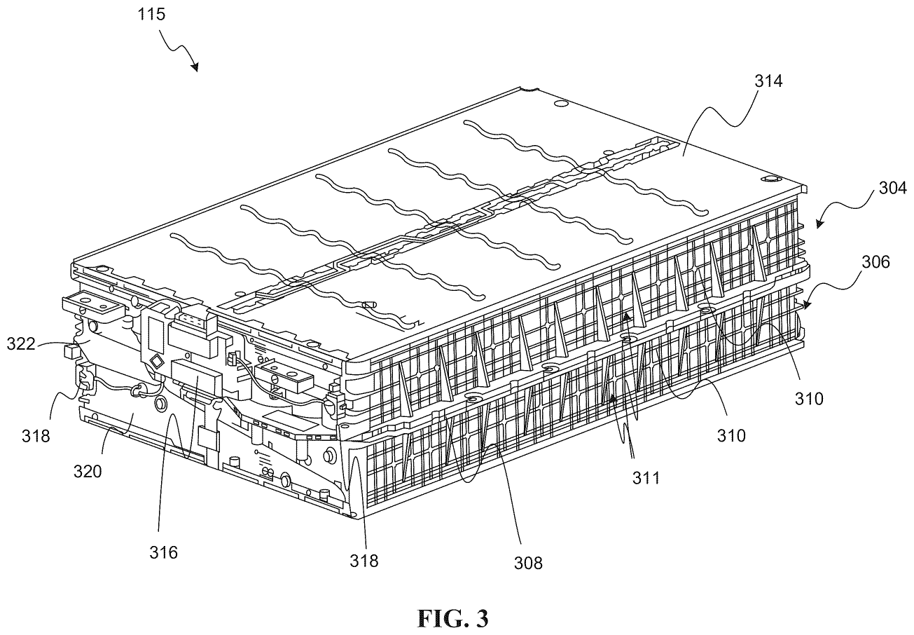

FIG. 3 illustrates a perspective view of a battery module in accordance with one or more implementations. In the example of FIG. 3, the battery module 115 includes a top submodule 304 and a bottom submodule 306. As shown, each of the top submodule 304 and the bottom submodule 306 may include a cell carrier 310. In one or more implementations, each cell carrier 310 may be a monolithic unitary body (e.g., a molded body formed from plastic and/or other materials), and may include structural features 311 along the sidewalls thereof. These structural features 311 may reinforce the strength of the sidewalls of the carrier, and thereby reduce or eliminate the need for additional structural reinforcing components for the battery module 115, such as shear walls attached to the cell carriers 310. Also visible in FIG. 3 is a cold plate 308 that is disposed between the top submodule 304 and the bottom submodule 306. The cold plate 308 may be in thermal contact with battery cells (not visible in FIG. 3) in the top submodule 304 and battery cells (not visible in FIG. 3) in the bottom submodule 306, to provide thermal control for both the top submodule 304 and the bottom submodule 306.

A current collector assembly (CCA) 400 is also visible in FIG. 3. As described in further detail hereinafter, the CCA 400 may couple multiple battery cells 120 in the battery module 115 (e.g., or sub-module or subassembly thereof) to one or more busbars, such as busbar 320 and/or busbar 322. FIG. 3 also illustrates a cover 314 that may be disposed on a top and/or a bottom of the battery module 115 (e.g., over the CCA 400). FIG. 3 also illustrates how one or more mechanical structures and/or electrical components can be mounted along a side of the battery module 115. For example, FIG. 3 illustrates how the battery module 115 may include a balancing voltage and temperature (BVT) module 316 to which multiple thermistor assemblies 318 are communicatively coupled. The BVT can be a modular assembly of various electrical components to monitor or control components of the battery subassembly. For example, the BVT can include a circuit board that is attached to the housing of the BVT. The BVT can have various connectors to couple with, for example, a thermistor that can measure a temperature of the battery subassembly, battery module and/or a battery cell thereof, a voltage sensor or balancer that can sense or control voltage that flows through the battery subassembly, battery module and/or a battery cell thereof, or a communication device that can receive, transmit, or analyze data associated with the battery subassembly, battery module and/or a battery cell thereof. Also shown in FIG. 3 are a busbar 320 (e.g., a positive busbar) that is electrically coupled to first terminals (e.g., the positive terminals) of the battery cells of the top submodule 304 and the bottom submodule 306, and a busbar 322 (e.g., a negative busbar) that is electrically coupled to second terminals (e.g., the negative terminals) of the battery cells of the top submodule 304 and the bottom submodule 306. FIG. 3 also illustrates how the cell carriers 310 may each include a flange 331. The flange 331 may be used as a mounting surface for mounting the battery module 115 in a battery pack 110.

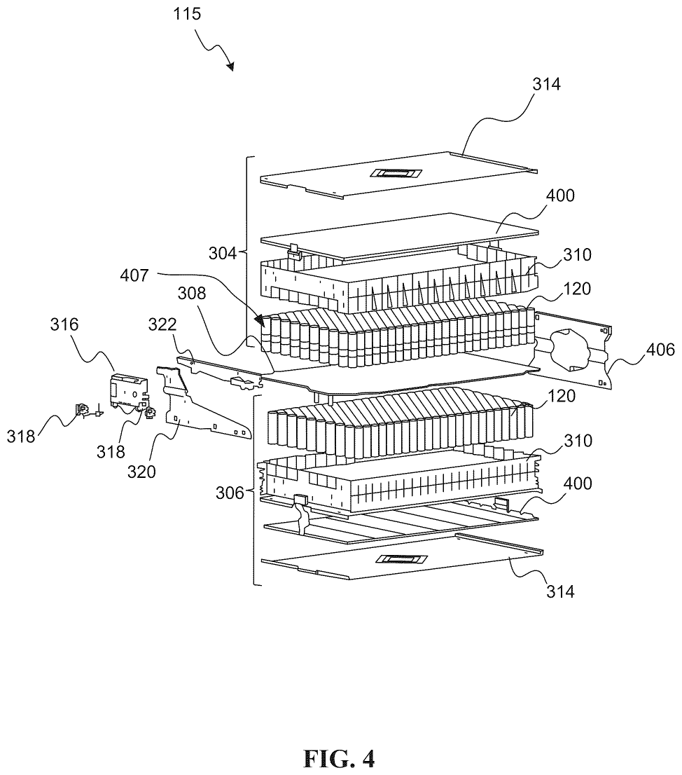

FIG. 4 illustrates an exploded perspective view of the battery module 115 of FIG. 3, in which the battery cells 120 of the top submodule 304 and the battery cells 120 of the bottom submodule 306 can be seen. In one or more examples described herein, the battery module 115, a subset of the components of the battery module 115 (e.g., the top submodule 304, the bottom submodule 306, and/or another subset of the components of the battery module) shown in FIG. 3 and/or FIG. 4, or any other grouping of battery cells (e.g., including a battery pack that includes multiple battery modules and/or other battery subassemblies) may be referred to as a battery subassembly.

In the example of FIG. 4, two current collector assemblies (CCAs) 400 are also visible which, when the battery module 115 is assembled, connect the terminals of the battery cells 120 of the top submodule 304 and the bottom submodule 306 to the busbar 320 and the busbar 322. As shown, the CCAs 400 may form respective top and bottom surfaces of the battery module 115 (e.g., before a potting material and/or a cover is applied thereto). As shown in FIG. 4, a series busbar 406 may also be provided (e.g., on an opposing end of the cell carriers 310 from the end of the cell carriers at which the busbar 320 and the busbar 322 are mounted). For example, the series busbar 406 may electrically couple the battery cells 120 of the top submodule 304 to the battery cells 120 of the bottom submodule 306. As shown, a cover 314 may be provided for the top submodule 304 and a cover 314 may be provided for the bottom submodule 306.

In one or more implementations, the battery cells 120 of the top submodule 304 may be inserted into a crate structure formed by the cell carrier 310 of the top submodule 304, and the battery cells 120 of the bottom submodule 306 may be inserted into a crate structure formed by the cell carrier 310 of the bottom submodule 306. As shown in FIGS. 3 and 4, the orientation of the cell carrier 310 and the battery cells 120 of the top submodule 304 may be substantially opposite (e.g., upside down with respect) to the orientation of the cell carrier 310 and the battery cells 120 of the bottom submodule 306. In this way, the single cold plate 308 can be in thermal contact with the same ends (e.g., bottom ends) of the battery cells 120 of both the top and bottom submodules, and provide substantially symmetric thermal contact with the top and bottom submodules. As shown in FIG. 4, the battery cells 120 may be arranged in rows 407 of battery cells 120.

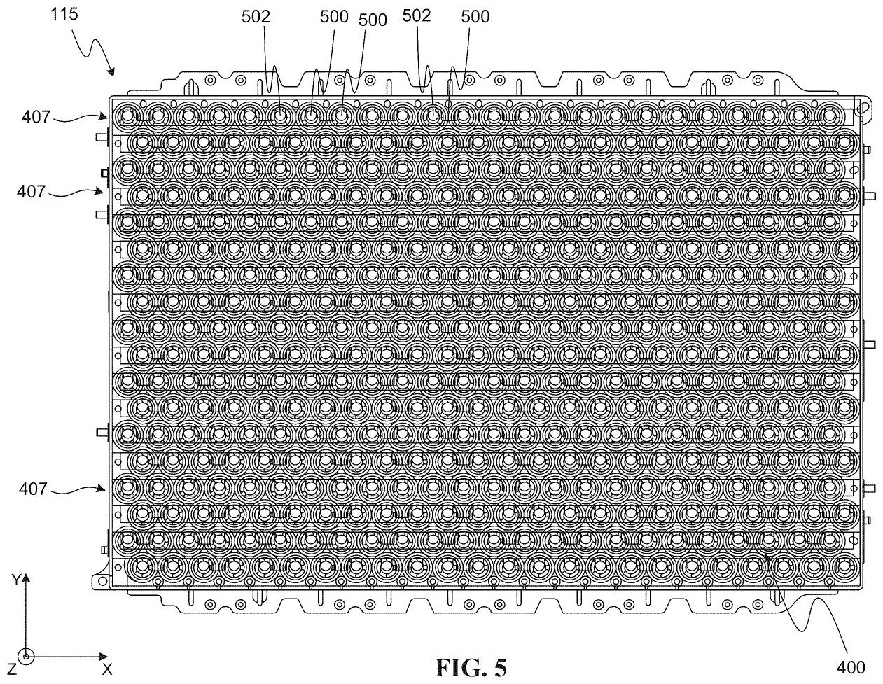

FIG. 5 illustrates a top view of a battery module 115 having a current collector assembly (CCA) 400. In one or more implementations, the CCA 400 may be a multi-layer current collector assembly. As shown in FIG. 5, the CCA 400 may include multiple tabs that each connect to (e.g., are welded to) one or more battery cells 120 in the rows 407 of the battery cells 120. For example, the tabs may include a first set of tabs 500 and a second set of tabs 502. The first set of tabs 500 may be part of a first conductive layer of the CCA 400, and the second set of tabs 502 may be part of a second conductive layer of the CCA 400. The first conductive layer and the second conductive layer may be vertically separated from each other (e.g., in a Z direction, out of the page, in FIG. 5) by an insulating layer.

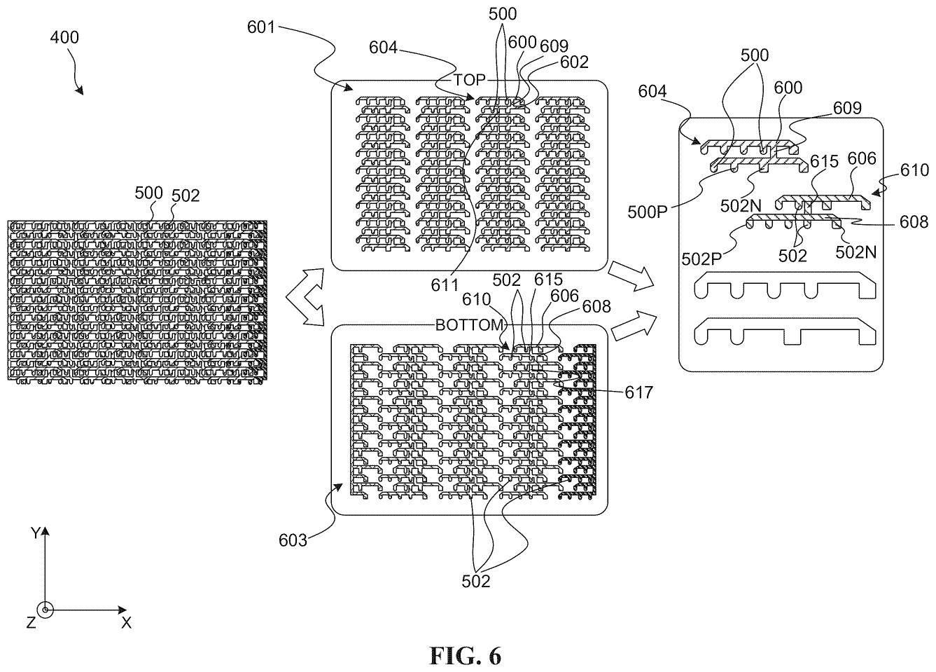

FIG. 6 illustrates a top view of the CCA 400. As illustrated in FIG. 6, the CCA 400 may include a first conductive layer 601 having the first set of tabs 500, each configured to electrically connect to at least one battery cell 120 of in a first row 407 of battery cells 120. The CCA 400 may also include a second conductive layer 603 having the second set of tabs 502, each configured to electrically connect to at least another battery cell 120 in the first row 407 of battery cells 120.

The first conductive layer 601 may have a thickness (e.g., in the Z direction of FIG. 6) that is about the same as a thickness (e.g., in the Z direction of FIG. 6) of the second conductive layer 603. As examples, the thickness of the first conductive layer 601 may be less than or equal to 0.4 millimeters (mm), less than or equal to 0.3 mm, between 0.05 millimeters and 0.2 mm, between 0.2 mm and 0.4 mm, or between 0.1 mm and 0.7 mm. As examples, the thickness of the second conductive layer 601 may be less than or equal to 0.4 millimeters (mm), less than or equal to 0.3 mm, between 0.05 millimeters and 0.2 mm, or between 0.2 mm and 0.4 mm. A possible advantage of making sheet thicknesses the same may be to provide a cost structure advantage through a common material sheet.

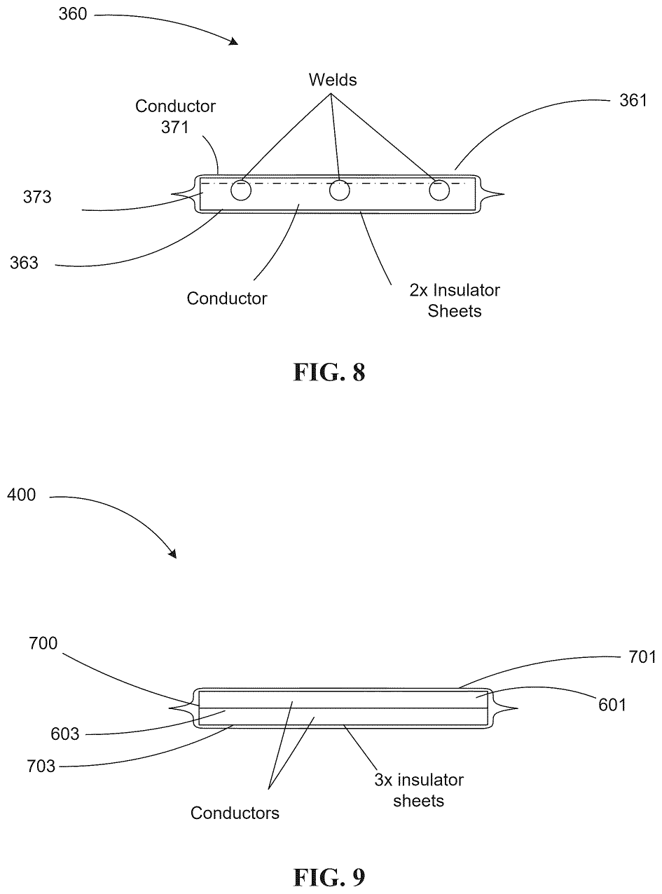

Some current collector assemblies include a thick conductor (e.g., having a thickness of as much as or more than 0.5 mm) to manage high currents, and a thin conductive layer (e.g., having a thickness of as much as or more than 0.125 mm), welded to the thick conductive conductor, to provide a viable welding substrate to the battery cells. In these current collector assemblies, the thick layer can be too thick for the cell weld and thus does not include any tabs. The thin conductive layer with tabs is welded to the thick conductor. The thin conductive layer may also be welded to the thick conductive layer to facilitate an integrated cell fuse, which is increasingly less feasible (e.g., becoming narrower and longer for increasing thickness) to package and manufacture in thicker conductors. FIG. 8 illustrates an example CCA 360, in which there may be a thick conductor (e.g., conductive layer 373) and a thin conductor (e.g., conductive layer 371), in which conductive layer 373 and conductive layer 371 may be welded together. As shown, there may be an insulating layer 361 and insulating layer 363 for CCA 360.

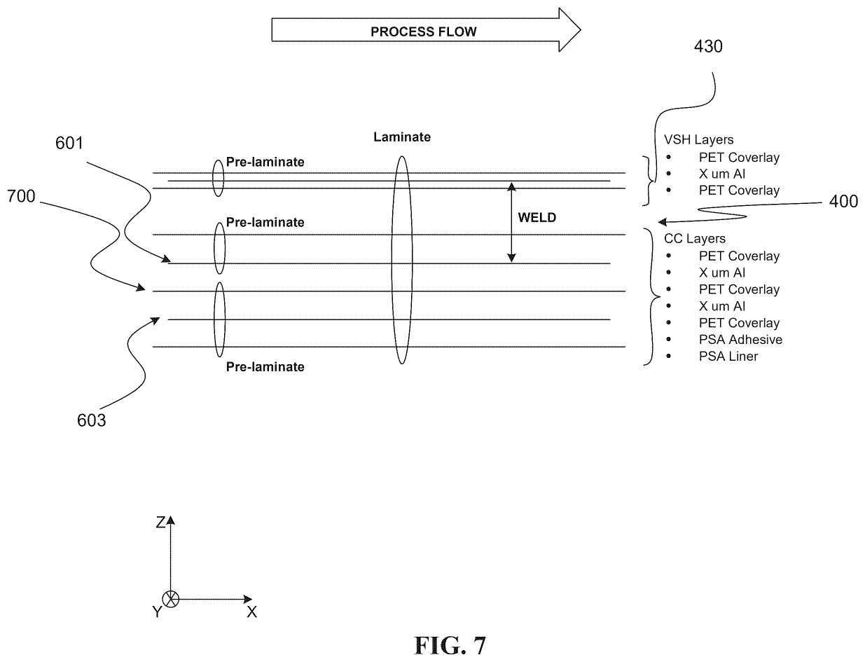

The current collector assembly 400 disclosed herein, with stacked (e.g., vertically separated) conductive layers of similar thickness (e.g., a thickness of less than 0.3 mm or a thickness of 0.1625 mm in some examples), may eliminate the need for two layers of significantly different thickness (thick and thin), and/or a need to weld two such layers together. For example, the current collector assembly 400 disclosed herein may stack the two separate conductors on top of each other, separated by an insulator, instead of nesting welded thin layers in an interlocking fashion in the same plane. Thus, the current collector assembly 400 disclosed herein may provide an improvement to the thick/thin welded-layer CCA design, as two vertical layers of conductors of about the same conductor thickness can be laminated together with an insulator therebetween, which may eliminate an additional welding process to join the thick and thin conductors together. FIG. 7 illustrates an example side view of the configuration and process of the disclosed CCAs 400. As, shown there may be only a weld between the CCA 400 and voltage harness 430 (e.g., voltage sensing harness—VSH), but there may be no requirement to weld between the first conductive layer 601 and the second conductive layer 603.

As shown in FIG. 7, the CCA 400 may include an insulating layer 700 separating the first conductive layer 601 and the second conductive layer 603. There may also be an insulating layer 701 and an insulating layer 703. As shown, the first conductive layer 601 may be stacked (e.g., vertically stacked) over the second conductive layer 603 in a vertical direction (e.g., in the Z-direction of FIG. 7). FIG. 7 also illustrates aspects of an example process flow for producing the CCA 400. FIG. 9 is an example side view of CCA 400, in which there may be a first conductor (e.g., conductive layer 601) and a second conductor (e.g., conductive layer 603), in which conductive layer 601 and conductive layer 603 may be about the same thickness. As shown, there may be a plurality of insulating layers, such as an insulating layer 701 above conductive layer 601 (in the z-direction), an insulating layer 700 between the conductive layer 601 and conductive layer 603, and an insulating layer 703 below the conductive layer 603 (in the z-direction) for CCA 400. Conductive layer 601 and conductive layer 603 may be monolithic conductive layers laminated together (e.g., no welding) with an insulating layer 700. CCA 400 allows for electrical isolation between the conductive layers may allow for more compact designs. In addition, in an example implementation conductive layer 601 may connect with positive terminals of certain battery cells while the conductive layer 603 may connect with negative terminals of other battery cells, electrical isolation between these layers may used to prevent short circuits. Without such isolation, the overlapping conductive layer may create direct electrical paths between positive and negative terminals, rendering the battery assembly inoperable and potentially creating hazardous conditions.

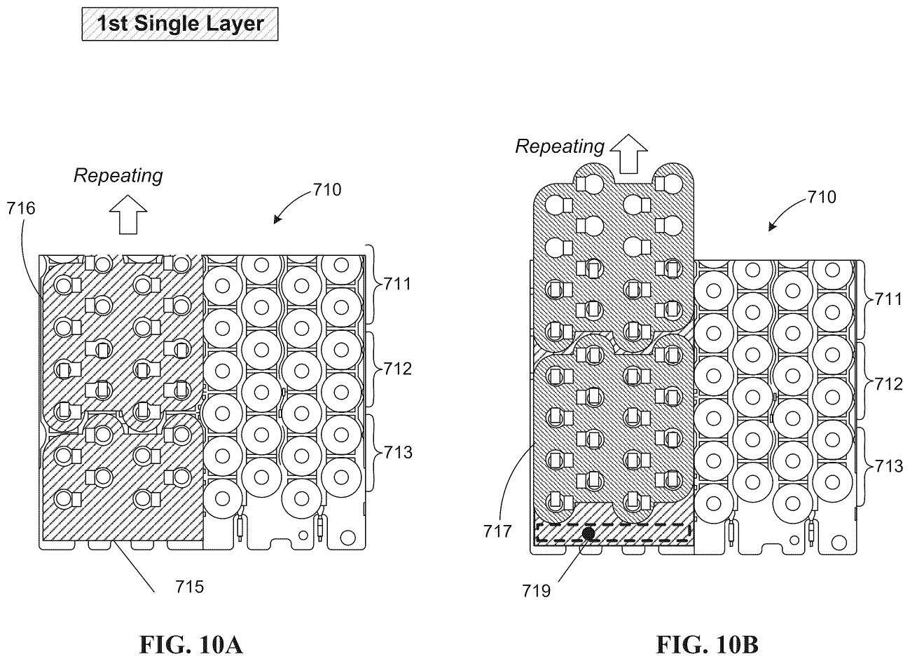

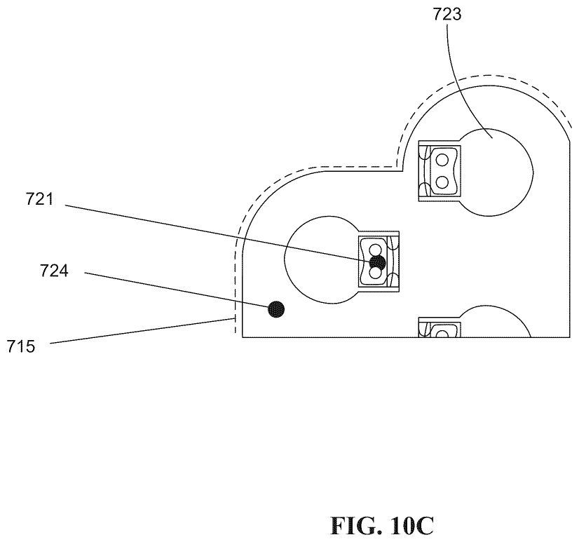

Returning to FIG. 6, the first set of tabs 500 may be spaced apart from each other and the second set of tabs 502 may be spaced apart from each other along a horizontal direction (e.g., the X direction of FIG. 6) perpendicular to the vertical direction (e.g., the Z direction of FIG. 6), and a first one of the second set of tabs 502 may be disposed between first and second ones of the first set of tabs 500. As shown, the first conductive layer may include a first elongated bar (e.g., elongated bar 600, which may alternatively be considered more generally a conductive layer/conductive island such as shown in FIG. 10A or FIG. 10B), the first set of tabs 500 may extend in a first direction (e.g., the negative Y direction of FIG. 6) from the first elongated bar, the second conductive layer 603 may include a second elongated bar (e.g., elongated bar 606), and the second set of tabs 502 may extend in the first direction (e.g., the negative Y direction of FIG. 6) from the second elongated bar. In this example all of the tabs 500 and 502 extend (e.g., from their respective elongated bars) in the same direction (e.g., the negative Y direction of FIG. 6). However, in one or more other implementations one or more tabs may extend in a different direction (e.g., an opposite direction, such as the positive Y direction of FIG. 6) from one or more of the elongated bars. In one or more of these other implementations, tabs extending from one elongated bar (e.g., elongated bar 600) may be interdigitated with tabs extending from another elongated bar (e.g., elongated bar 602).

In one or more implementations, at least one (e.g., tab 500N) of the first set of tabs 500 may be configured to connect to a first pair of the battery cells 120 in the first row 407 (e.g., to two negative terminals of two adjacent battery cells in the same row 407), and at least one (e.g., tab 502N) of the second set of tabs 502 may be configured to connect to a second pair of the battery cells in the first row. The first set of tabs 500 may include at least one tab (e.g., tab 500P) configured to connect to a first polarity (e.g., positive) terminal of one of the battery cells 120 in the first row 407, and the at least one tab (e.g., tab 500N) that is configured to connect to the first pair of the battery cells in the first row may be configured to connect to second polarity (e.g., negative) terminals of the first pair of the battery cells. The second set of tabs 502 may include at least one tab (e.g., tab 502P) configured to connect to a first polarity (e.g., positive) terminal of another one of the battery cells 120 in the first row 407, and the at least one tab (e.g., tab 502N) that is configured to connect to the second pair of the battery cells in the first row may be configured to connect to second polarity (e.g., negative) terminals of the second pair of the battery cells.

The first conductive layer 601 may include a first elongated bar (e.g., an elongated bar 600 that is elongated along the X direction of FIG. 6), a first group of the first set of tabs 500 extending from the first elongated bar (e.g., in the negative Y direction of FIG. 6), a second elongated bar (e.g., elongated bar 602 that is elongated along the X direction of FIG. 6) electrically coupled (e.g., via a connector structure 609) to and horizontally separated (e.g., separated in the negative Y direction of FIG. 6) from the first elongated bar, and a second group of the first set of tabs 500 extending (e.g., in the negative Y direction of FIG. 6) from the second elongated bar. The first group of the first set of tabs 500 that extend from the elongated bar 600 may connect a set of battery cells 120 (e.g., in the first row of battery cells) together in series (e.g., along a first direction such as the X direction of FIG. 6) to stack up a desired (e.g., threshold) voltage for output by the battery subassembly. The second group of the first set of tabs 500 that extend from the elongated bar 602 may connect another set of battery cells 120 (e.g., in another row of the battery cells) together (e.g., along the X direction of FIG. 6) in series to stack up the desired (e.g., threshold) voltage for output by the battery subassembly. Connecting the elongated bar 600 to the elongated bar 602 with the connector structure 609 (e.g., along the Y direction of FIG. 6) may connect the sets of battery cells together in parallel to increase the energy that can be provided by the battery subassembly.

The first elongated bar (e.g., elongated bar 600), the first group of the first set of tabs 500, the second elongated bar (e.g., elongated bar 602), and the second group of the first set of tabs 500 form a tab group structure 604 of the first conductive layer 601. As shown in FIG. 6, the first conductive layer 601 may also include multiple additional tab group structures (e.g., in a repeating pattern of the geometry of the tab group structure 604 that includes two elongated bars electrically coupled together and horizontally spaced apart, with tabs extending from each of the two elongated bars) electrically coupled (e.g., by connector structures 611) to and horizontally separated from the tab group structure 604 in a first horizontal direction (e.g., in the negative Y direction of FIG. 6). Connecting the tab group structures 604 together with the connector structures 611 (e.g., along the Y direction of FIG. 6) may connect additional sets of battery cells together in parallel to further increase the energy that can be provided by the battery subassembly. As shown in FIG. 6, the first conductive layer 601 may also include multiple further additional tab group structures electrically coupled to each other and horizontally separated from the tab group structure and the additional tab group structures in a second horizontal direction (e.g., in the X and negative X directions of FIG. 6).

The second conductive layer 603 may include a third elongated bar (e.g., an elongated bar 606 that is elongated along the X direction of FIG. 6), a first group of the second set of tabs 502 extending (e.g., in the negative Y direction of FIG. 6) from the third elongated bar, a fourth elongated bar (e.g., elongated bar 608 that is elongated along the X direction of FIG. 6) electrically coupled (e.g., via a connector structure 615) to and horizontally separated from the third elongated bar, and a second group of the second set of tabs 502 extending (e.g., in the negative Y direction of FIG. 6) from the fourth elongated bar. The first group of the second set of tabs 502 that extend from the elongated bar 606 may connect yet another set of battery cells 120 (e.g., in the first row of battery cells) together in series (e.g., along the X direction of FIG. 6) to stack up the desired voltage for output by the battery subassembly. The second group of the second set of tabs 502 that extend from the elongated bar 608 may connect still another set of battery cells 120 (e.g., in the other row of the battery cells) together in series (e.g., along the X direction of FIG. 6) to stack up the desired voltage for output by the battery subassembly. Connecting the elongated bar 606 to the elongated bar 608 with the connector structure 615 (e.g., along the Y direction of FIG. 6) may connect the further and still additional sets of battery cells together in parallel to increase the energy that can be provided by the battery subassembly.

The third elongated bar (e.g., elongated bar 606), the first group of the second set of tabs 502, the fourth elongated bar (e.g., elongated bar 608), and the second group of the second set of tabs 502 may form a tab group structure 610 of the second conductive layer 603. As shown in FIG. 6, the second conductive layer 603 may also include multiple additional tab group structures (e.g., in a repeating pattern of the geometry of the tab group structure 610) electrically coupled (e.g., by connector structures 617) to and horizontally separated from the tab group structure 610 of the second conductive layer 603 in the first horizontal direction (e.g., along the negative Y direction of FIG. 6). Connecting the tab group structures 610 together with the connector structures 617 (e.g., along the Y direction of FIG. 6) may connect more sets of battery cells together in parallel to further increase the energy that can be provided by the battery subassembly. The second conductive layer 603 may also include multiple further additional tab group structures electrically coupled to each other and horizontally separated from the tab group structure of the second conductive layer and the additional tab group structures second conductive layer in the second horizontal direction (e.g., in the X and negative X directions of FIG. 6).

As shown in FIG. 6, the first elongated bar (e.g., elongated bar 600) of the first conductive layer 601 may at least partially overlap the third elongated bar (e.g., elongated bar 606) of the second conductive layer 603 in the vertical direction (e.g., in the X direction). As shown in FIG. 6, the first group of the first set of tabs 500 (e.g., extending from the elongated bar 600) may include a tab arrangement (e.g., an arrangement of positive and negative tabs 500P and 500N in various locations) that is different from a tab arrangement of the second group of the first set of tabs 502 (e.g., extending from the elongated bar 602), different from a tab arrangement of the first group of the second set of tabs 502 (e.g., extending from the elongated bar 606), and/or different from a tab arrangement of the second group of the second set of tabs 502 (e.g., extending from the elongated bar 608). It is appreciated that the specific arrangement of tag group structures and tabs in FIGS. 5 and 6 are merely illustrative, and that tab group structures and tabs for multiple vertically separated conductive layers may be arranged differently to accommodate various different arrangements of underlying battery cells as further shown in FIG. 9.

FIG. 10A and FIG. 10B illustrate another embodiment of the multi-layer stack CCA which may be placed on another battery cell configuration. FIG. 10A illustrates a top view of a first single layer (e.g., conductive layer 601) of a portion of a current collector assembly 400 positioned above battery cells according to one or more implementations. FIG. 10B illustrates a top view of a first single layer (e.g., conductive layer 601) and a second single layer (e.g., conductive layer 603) of CCA 400 positioned above battery cells according to one or more implementations.

As shown in FIG. 10A and FIG. 10B, battery cells 710 may be arranged in a grid pattern of rows and columns, with alternating parallel battery groups (e.g., P-group 711, P-group 712, or P-group 713) shown in different shading to indicate distinct parallel groups. There may be repeating conductive islands (e.g., conductive island 715 associated with conductive layer 601 or conductive island 717 associated with conductive layer 603) configured to electrically connect designated battery cells within each parallel group. As shown in FIG. 10B, conductive layer 603 may include a complementary pattern of conductive islands with conductive layer 601 with a string termination region 719 (pos/neg terminal) at its lower portion. In FIG. 10B, conductive island 717 may overlap with conductive island 715 and conductive island 716, which may assist with interconnecting parallel battery groups. The string termination region 719 may provide positive terminals or negative terminals for the assembly. The conductive islands in both layers may be positioned to align with corresponding battery cell terminals while maintaining electrical separation between parallel groups. The battery cells may be implemented as cylindrical cells, such as 2170-format or 4680-format cells in various implementations.

FIG. 10C illustrates an example top down view of a portion of a conductive island, such as conductive island 715 or conductive island 717. Conductive island 715 (or conductive island 717) may include a weld tab portion 721 configured to electrically connect to a battery cell terminal, an opening 723, and a remaining portion 724 that may provide current routing capabilities. The weld tab portion 721 may be specifically dimensioned and positioned to facilitate welding to a battery cell terminal while maintaining proper electrical contact. Conductive island structures may be repeated across CCA 400 to create connections with multiple battery cells in a parallel group or other configuration.

In one or more implementations, the current collector assembly 400 may include openings or holes to facilitate battery module assembly and operation. For example, conductive layer 601, conductive layer 603, and insulating layers 700, 701, 703 may include aligned openings for potting material ingress during module assembly. Insulating layers 700, 701, 703 may also include openings or paths for integration with voltage sensing harnesses or other electrical components.

As discussed herein, the CCA 400 may be implemented in a battery subassembly, such as the battery module 115, in a battery pack 110, and/or in a vehicle, such as the vehicle 100.

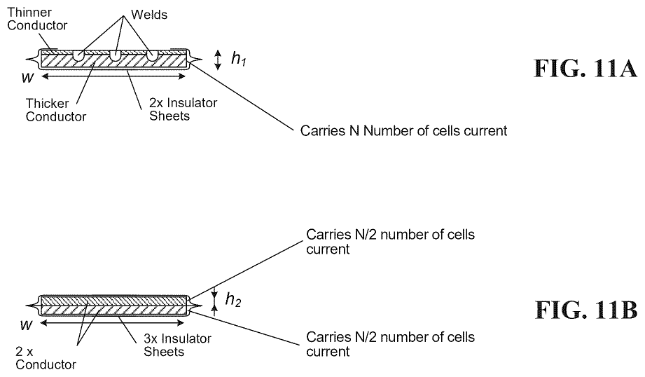

In some CCAs, conductive “fingers” may be staggered every other row, and each group of fingers may interlock/nest with a next group of fingers (e.g., by extending in an opposite direction (toward) each other in an interlocking pattern). In these CCAs, each finger may collect current from the cells on either side of it (e.g., from eight cells in some examples). In the CCA 400 of FIGS. 5-7, a “finger” or tab group structure may be provided on every row, and a next group of fingers (e.g., a tab group of the other conductive layer) may be shingled on a second layer on top or bottom of the previous, separated by an insulator (e.g., the insulating layer 700). In this arrangement, the groups of collectors may alternate top-bottom-top-bottom-etc. In this fashion, each finger may be arranged to collect current from battery cells on one side only, and thus half the cells (e.g., four cells in some examples), and thus half of the current of an interlocking design. Collecting half the current means that the conductive layer(s) may be one quarter the thickness for the same length and width (e.g., the cross section may be decreased to one quarter), noting that the heat generation in a conductor is proportional to the square of the current multiplied by the resistance (e.g., P=I²R, or IIR). FIG. 11A illustrates two electrically connected conductive layers laminated between insulating layers. FIG. 11B illustrates two electrically separate conductive layers laminated between insulating layers. FIG. 11A and FIG. 11B (reflecting FIG. 8 and FIG. 9 respectively) illustrates additional detail with regard to considerations for heat generation or heat dissipation with regard to conductive layer thickness, among other things. By halving the current, the resistance can increase by 4× for the same heat generation. Thus, the conductor cross section can be one quarter (e.g., the conductor thickness can be one quarter), in comparison with interlocking designs. The alternating top/bottom arrangement of the two stacked single conductive layers 601 and 603 may also provide some more overall part rigidity and/or structure for handling.

With continued reference to FIG. 11, the following is an example analysis associated with conductor thickness reducing with lower current to maintain heat dissipation. Heat generation may be governed by P=I²R, wherein P=power dissipated, I=current through conductor, and R=resistance of conductor. Resistance (R) may be governed by R=ρ×(L/A), wherein ρ is the resistivity of the material (an intrinsic property), and L is the length of the conductor. A may be the cross-sectional area of the conductor, defined as A=width (w)×height (h). With reference to constant parameters, L, w, and ρ may remain constant for each design. Heat generation may be proportional to the conductor thickness, P is proportional to I²h (e.g., P′I²h). If the Number of Cells is Halved (Resulting in Half Current), solving for the new height assuming the same heat dissipation with half the current, equating power dissipation: P₁=P₂. Solving for h₁ may lead to h₁=(¼)h₂. The height of a single conducting plane may be one-fourth of the original design. For the total conductor stack, the thickness may be half of an original design.

The CCA 400 disclosed herein may provide advantages in terms of supply chain complexity, manufacturing complexity, weight, and/or cost. For example, using conductive layers having the same thickness of material (e.g., vs two different thickness) may simplify the supply chain and improve cost. Using conductive layers of the same thickness may eliminate manufacturing steps associated with welding together layers of different thicknesses, such as thick and thin layers that are traditionally used. Additionally, eliminating the welding process between conductive layers may reduce manufacturing complexity and potential failure points. The overall amount of conductor may also be lower and improve weight and/or cost. An additional layer of insulator may be provided to separate the top and bottom conductive layers, however, manufacturing processes for patterned conductors may include a carrying layer that would be otherwise sacrificed and may be utilized as the insulator for a cost-neutral position for the added insulator. Thinner conductive layers (e.g., layers having a thickness less than 0.3 millimeters) may be cut more efficiently using scan head lasers, whereas thicker layers may require fixed-beam lasers mounted on mechanical gantries, which may operate more slowly.

In an example, a current collector assembly may include a first conductive layer having a first plurality of tabs, each (e.g., such respective first plurality of tabs) configured to electrically connect to at least one battery cell in a first row of battery cells; a second conductive layer having a second plurality of tabs, each configured to electrically connect to at least another battery cell in the first row of battery cells; and an insulating layer separating the first conductive layer and the second conductive layer. The first conductive layer may have a thickness that is the same as a thickness of the second conductive layer and may be less than 0.3 millimeters. The first conductive layer may be stacked over the second conductive layer in a vertical direction, with the first plurality of tabs and the second plurality of tabs spaced apart along a horizontal direction perpendicular to the vertical direction, such that a first one of the second plurality of tabs is disposed between first and second ones of the first plurality of tabs. The first conductive layer may include a first elongated bar, with the first plurality of tabs extending in a first direction from the first elongated bar, and the second conductive layer may include a second elongated bar, with the second plurality of tabs extending in the first direction from the second elongated bar. At least one of the first plurality of tabs may be configured to connect to a first pair of the battery cells in the first row, while at least one of the second plurality of tabs may be configured to connect to a second pair of the battery cells in the first row. The first plurality of tabs may include at least one tab configured to connect to a first polarity terminal of one of the battery cells in the first row, while another tab in the first plurality of tabs may connect to second polarity terminals of the first pair of battery cells. Similarly, the second plurality of tabs may include at least one tab configured to connect to a first polarity terminal of another battery cell in the first row, with another tab in the second plurality of tabs configured to connect to second polarity terminals of the second pair of battery cells. The first conductive layer may further include a first elongated bar, a first group of the first plurality of tabs extending from the first elongated bar, a second elongated bar electrically coupled to and horizontally separated from the first elongated bar, and a second group of the first plurality of tabs extending from the second elongated bar. The first elongated bar, the first group of the first plurality of tabs, the second elongated bar, and the second group of the first plurality of tabs may form a tab group structure of the first conductive layer, wherein the first conductive layer may further include additional tab group structures electrically coupled to and horizontally separated from the tab group structure in a first horizontal direction. The first conductive layer may also include a plurality of further additional tab group structures electrically coupled to each other and horizontally separated from the tab group structure and the additional tab group structures in a second horizontal direction. The first elongated bar of the first conductive layer may at least partially overlap a third elongated bar of the second conductive layer in the vertical direction, and the first group of the first plurality of tabs may include a tab arrangement different from a tab arrangement of the second group of the first plurality of tabs and a tab arrangement of the first group of the second plurality of tabs. All combinations (including the removal or addition of steps or components) in this paragraph and the above paragraphs are contemplated in a manner that is consistent with the other portions of the detailed description.

In an example, a battery subassembly may include a current collector assembly that includes a first conductive layer having a first plurality of tabs, each configured to electrically connect to at least one battery cell in a first row of battery cells; a second conductive layer having a second plurality of tabs, each configured to electrically connect to at least another battery cell in the first row of battery cells; and an insulating layer separating the first conductive layer and the second conductive layer. The battery subassembly may further include a plurality of battery cells arranged in rows that include the first row of battery cells, wherein each of the first plurality of tabs is electrically connected with at least one of the battery cells in the first row. The battery subassembly may include a battery module comprising a first battery subassembly having the current collector assembly and a second battery subassembly having an additional current collector assembly. A first group of the first plurality of tabs may connect a first group of battery cells together in series along a first direction to stack up a desired (e.g., threshold) voltage for the battery subassembly. The current collector assembly may further include one or more connector structures that connect the first group of battery cells, via the first group of the first plurality of tabs, the one or more connector structures, and a second group of the first plurality of tabs, to another group of battery cells in parallel along a second direction perpendicular to the first direction, to increase the energy output of the battery subassembly. The current collector assembly may further include a repeating geometry of the first plurality of tabs along the second direction to further increase the energy capacity of the battery subassembly. All combinations (including the removal or addition of steps or components) in this paragraph and the above paragraphs are contemplated in a manner that is consistent with the other portions of the detailed description.

A vehicle may include a current collector assembly that includes a first conductive layer having a first plurality of tabs, each configured to electrically connect to at least one battery cell in a first row of battery cells; a second conductive layer having a second plurality of tabs, each configured to electrically connect to at least another battery cell in the first row of battery cells; and an insulating layer separating the first conductive layer and the second conductive layer. The vehicle may further include a battery pack including a battery subassembly that includes the current collector assembly. The current collector assembly may include repeating conductive islands associated with the first conductive layer and the second conductive layer. All combinations (including the removal or addition of steps or components) in this paragraph and the above paragraphs are contemplated in a manner that is consistent with the other portions of the detailed description.

Aspects of the subject technology can help improve the efficiency and/or range of electric vehicles. This can help facilitate the functioning of and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A current collector assembly, comprising:
a first conductive layer having a first plurality of tabs, such respective first plurality of tabs configured to electrically connect to at least one battery cell of in a first row of battery cells;
a second conductive layer having a second plurality of tabs, such respective second plurality of tabs configured to electrically connect to at least another battery cell in the first row of battery cells; and
an insulating layer separating the first conductive layer and the second conductive layer.

2. The current collector assembly of claim 1, wherein the first conductive layer has a first thickness that is the same as a second thickness of the second conductive layer.

3. The current collector assembly of claim 2, wherein the first conductive layer has thickness is less than 0.6 millimeters.

4. The current collector assembly of claim 1, wherein the first conductive layer is stacked over the second conductive layer in a vertical direction, and wherein the first plurality of tabs and the second plurality of tabs are spaced apart along a horizontal direction perpendicular to the vertical direction, and wherein a first tab of the second plurality of tabs is disposed between first tab and second tab of the first plurality of tabs.

5. The current collector assembly of claim 1, wherein the first conductive layer comprises a first conductive island, wherein the first plurality of tabs extend in a first direction from the first conductive island, and wherein the second conductive layer comprises a second conductive island, and wherein the second plurality of tabs extend in the first direction from the second conductive island.

6. The current collector assembly of claim 5, wherein at least one of the first plurality of tabs is configured to connect to a first pair of the battery cells in the first row, and wherein at least one of the second plurality of tabs is configured to connect to a second pair of the battery cells in the first row.

7. The current collector assembly of claim 6, wherein the first plurality of tabs comprises at least one tab configured to connect to a first polarity terminal of one of the battery cells in the first row and the at least one tab that is configured to connect to the first pair of the battery cells in the first row is configured to connect to second polarity terminals of the first pair of the battery cells, wherein the second plurality of tabs comprises at least one tab configured to connect to a first polarity terminal of another one of the battery cells in the first row and the at least one tab that is configured to connect to the second pair of the battery cells in the first row is configured to connect to second polarity terminals of the second pair of the battery cells.

8. The current collector assembly of claim 4, wherein the first conductive layer comprises a first conductive island, a first group of the first plurality of tabs extending from the first conductive island, a second conductive island electrically coupled to and horizontally separated from the first conductive island, and a second group of the first plurality of tabs extending from the second conductive island.

9. The current collector assembly of claim 8, wherein the first conductive island, the first group of the first plurality of tabs, the second conductive island, and the second group of the first plurality of tabs form a tab group structure of the first conductive layer, and wherein the first conductive layer further comprises a plurality of additional tab group structures electrically coupled to and horizontally separated from the tab group structure in a first horizontal direction.

10. The current collector assembly of claim 9, wherein the first conductive layer further comprises a plurality of further additional tab group structures electrically coupled to each other and horizontally separated from the tab group structure and the additional tab group structures in a second horizontal direction.

11. The current collector assembly of claim 8, wherein the first conductive island of the first conductive layer at least partially overlaps a third conductive island of the second conductive layer in the vertical direction.

12. The current collector assembly of claim 11, wherein the first group of the first plurality of tabs comprises a tab arrangement that is different from a tab arrangement of the second group of the first plurality of tabs and a tab arrangement of the first group of the second plurality of tabs.

13. A battery subassembly, comprising:
a current collector assembly, comprising:
a first conductive layer having a first plurality of tabs, such respective first plurality of tabs configured to electrically connect to at least one battery cell of in a first row of battery cells;
a second conductive layer having a second plurality of tabs, such respective second plurality of tabs configured to electrically connect to at least another battery cell in the first row of battery cells; and
an insulating layer separating first conductive layer and the second conductive layer.

14. The battery subassembly of claim 13, further comprising a plurality of battery cells arranged in rows that comprise the first row of battery cells, wherein the respective tab of the first plurality of tabs is electrically connected with at least one of the battery cells in the first row of battery cells, and, wherein the respective tab of the first plurality of tabs is electrically connected with at least one of the battery cells in the first row of battery cells.

15. The battery subassembly of claim 14, wherein the battery subassembly comprises a battery module comprising a first battery subassembly having the current collector assembly, and second battery subassembly having an additional current collector assembly.

16. The battery subassembly of claim 15, wherein a first group of the first plurality of tabs connect a first group of the battery cells together in series along a first direction to stack up a threshold voltage for the battery subassembly.

17. The battery subassembly of claim 16, wherein the current collector assembly comprises one or more connector structures that connect the first group of the battery cells, via the first group of the first plurality of tabs, the one or more connector structures, and a second group of the first plurality of tabs, to another group of the battery cells in parallel along a second direction perpendicular to the first direction, to increase an amount of energy to be provided by the battery subassembly.

18. The battery subassembly of claim 17, wherein the current collector assembly comprises a repeating geometry of the first plurality of tabs along the second direction to further increase the amount of energy to be provided by the battery subassembly.

19. A vehicle, comprising:
a current collector assembly, comprising:
a first conductive layer having a first plurality of tabs, such respective first plurality of tabs configured to electrically connect to at least one battery cell of in a first row of battery cells;
a second conductive layer having a second plurality of tabs, such respective second plurality of tabs configured to electrically connect to at least another battery cell in the first row of battery cells; and
an insulating layer separating first conductive layer and the second conductive layer.

20. The vehicle of claim 19, further comprising a battery pack including a battery subassembly that comprises the current collector assembly.
